(19) United States
(12) Patent Application Publication
(10) Pub. No.: US 2006/0213694 A1
(43) Pub. Date: Sep. 28, 2006

(54) Portable electronic scale

(76) Inventor: Steve Cobb, Seattle, WA (US)

Correspondence Address: JENSEN + PUNTIGAM, P.S., SUITE 1020, 2033 6TH AVE, SEATTLE, WA, 98121, US

(21) Appl. No.: 11/087,471

(22) Filed: Mar. 22, 2005

(51) Int. Cl. G01G 19/22

(52) U.S. Cl. 177/25.12

(57) ABSTRACT

A balance device that measures the static weight and magnetic force of a magnetically enhanced miniature toy vehicle. The device includes a top loading platform with a receiving slot for registering a miniature toy vehicle on the loading platform, a provision for a metal member that is mounted flush with but independently of the loading platform, providing a fixed metal object to create downward force against the working platform when the platform is loaded with a magnetically enhanced miniature toy vehicle. The loading platform is connected to a strain gauge to generate a load-dependent electrical signal, which can be measured and converted into a visual display of the miniature toy vehicles static weight and magnetic down-force combined.

This invention relates to electronic scales, but is specifically intended for the purpose of measuring the static weight and magnetic down-force of miniature toy vehicles known as slot cars.

Miniature toy vehicles commonly known by the term “slot cars” are used in conjunction with what is called a “slot car track”. These two items work together to simulate a car racing scenario that mimics that of life-size car racing, but on a much smaller scale. The slot car track, as mentioned above, utilizes two separate metallic strips that run parallel to a slot in the tracks surface. The primary purpose of the two metallic strips is to provide a power source to the slot car, which runs on electric current. But in addition to this function, the metallic strips also attract the magnet that is fitted to the under-carriage of the slot car. As a result, a performance enhancement is achieved when the slot car is pulled harder against the track surface by the magnetic force pulling against the metallic strips that are affixed to the tracks surface, in effect, creating more traction for the slot cars tires against the tracks surface. The performance increase that is gained via magnetic down-force varies greatly, depending on how much magnetic force is created by the magnet that is mounted in the slot car (i.e., the more magnetic down-force available, the more traction the slot car achieves and the faster the slot car can travel around the track.) Furthermore, the amount of magnetic down-force available can be varied significantly by raising or lowering the magnets position in the undercarriage of the slot car, which simply changes the distance between the magnet in the slot car and the metallic strips affixed to the track. It is important to understand that the closer the magnet is to the metallic strips, the more magnetic downward force is produced. This variable distance between the magnet and the metallic strips serves to alter the slot cars performance, or to simply “tune” the car to the users liking.

At a typical slot car racing event, there is usually a pre-race slot car inspection in an attempt to deem the car eligible for racing, as per the specific rules for that particular event. This usually includes a visual inspection of the slot cars magnet, for the purpose of determining if the magnet has been altered by the user in an effort to gain a competitive advantage. This visual inspection has been the source of much debate among slot car racers regarding its effectiveness. Mainly because of the wide margin of error and the limitations that are inherent to visually based inspection. The case being that it is simply too difficult to see the differences in the slot cars magnet position in relation to the tracks surface.

This invention allows for the accurate measurement of the magnetic force generated by the slot cars on-board magnet, thus giving the user a reference thereof. This information can then be used to help adjust the slot cars performance, to help regulate the cars performance, or to simply adjust the slot cars performance to the level desired by the user.

It is therefore the object of the invention to allow the user to measure the weight and specific magnetic down-force of slot cars that are fitted with magnets, for the purpose of determining or varying the slot cars performance.

Preferred embodiments of this invention will be described in detail below in connection with the following drawings, in which like numbers refer to like objects.

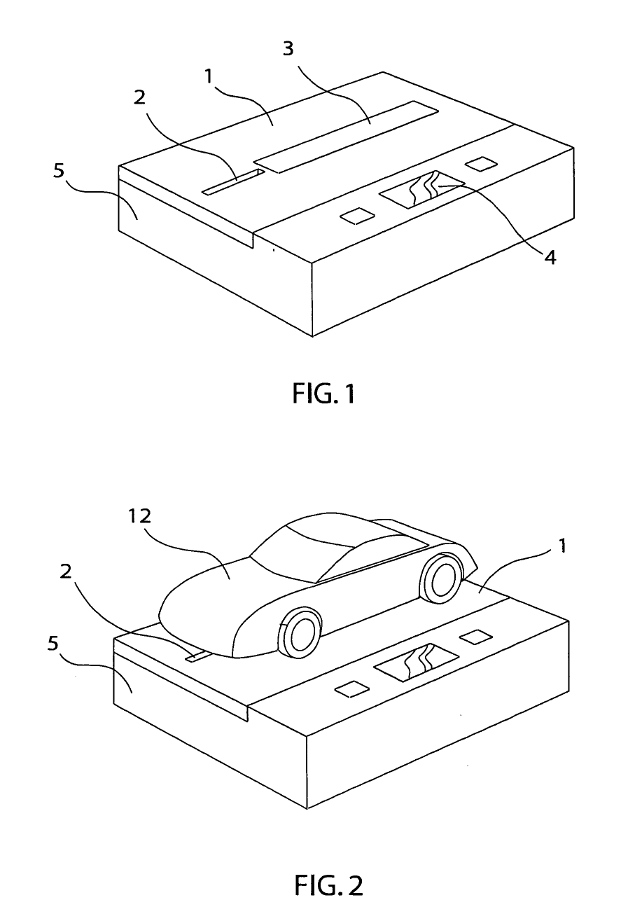

FIG. 1 shows an isometric view of a preferred embodiment of the invention and of various external features.

FIG. 2 shows an isometric view of a preferred embodiment of the invention laden with a miniature toy vehicle as in normal use.

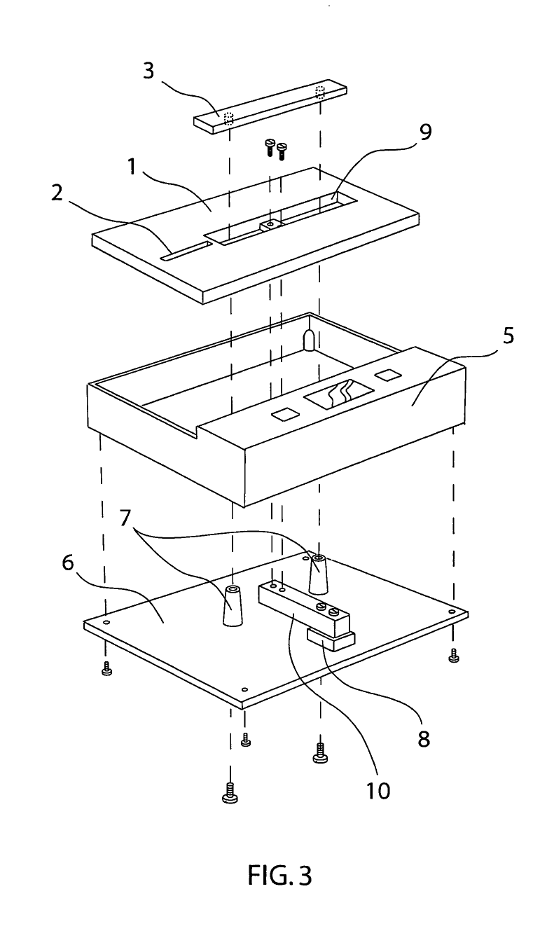

FIG. 3 shows an exploded isometric view of the preferred embodiment of the invention, depicting individual components and a possible method of assembly.

As shown in FIG. 1, The preferred embodiment of the invention should consist of a 5 enclosed housing, a top-loading platform 1, a receptor groove 2, a metallic member 3, and a visual display 4, which serves as a visual representation of the measured downward force. During normal operation, as depicted in FIG. 2, a slot car 12 is to be placed onto the top-loading platform 1 in a manner in which the guide of the slot car is inserted into the receptor groove 2 of the top-loading platform 1.

As seen in FIG. 2, the receptor groove 2 located in the top-loading platform 1 serves as a means to register the slot car 12 in parallel alignment with the top-loading platform 1 and metallic member 3. When the magnet that is mounted in the undercarriage of the slot car 12 comes in close proximity with the metallic member 3, the magnet is attracted to the metallic member 3 via magnetic force, and as a result this magnetic force creates increased down-force on the top-loading platform 1.

Referring to FIG. 3, To accurately measure this increased down-force, it is important to mount the base 8 of a strain gauge 10 and a support system for the metallic member 3 onto a common support structure 6. The support system of the preferred embodiment is depicted in the form of two protruding support pillars 7 in FIG. 3. This common support structure 6 of the strain gauge 8 mounting base, and protruding supports 7 for a metallic member 3 is integral to the function of the invention, in that it serves to focus magnetic down-force and combined static weight of the slot car downward onto the top-loading platform 1, which in turn, is mounted directly onto the load receiving end of the strain gauge 10.

Thus, as can be seen, the present invention provides a simple, inexpensive means to detect the downward force generated by the weight and magnetic element of a slot car.

1. A device for measuring the downward force generated by the weight and downward magnetic force of a slot car, comprising:
a housing supporting a vertically movable platform, wherein the platform includes a fixed metallic strip and elongated slot for appropriately positioning the slot car; and
a strain gauge mounted within the housing that measures the downward force on the platform, generated by the weight of the slot car and the magnetic force between the car and the fixed metallic strip.

2. The device of claim 1, wherein the housing provides a mounting system for a metallic strip to be mounted flush with but independent of the top-loading platform, so as to allow independent movement of the top-loading platform.
